(19) United States
(12) Patent Application Publication
(10) Pub. No.: US 2026/0088221 A1
(43) Pub. Date: Mar. 26, 2026

(54) MULTILAYER CERAMIC CAPACITOR AND METHOD OF MANUFACTURING THE SAME

(71) Applicant: SAMSUNG ELECTRO-MECHANICS CO., LTD., Suwon-si (KR)

(72) Inventors: Wonmi Choi, Suwon-si (KR); Byungkun Kim, Suwon-si (KR); Yuhong Oh, Suwon-si (KR); Dojeon Kim, Suwon-si (KR); Dongjun Jung, Suwon-si (KR); Jiyoung Lee, Suwon-si (KR); Hongseok Kim, Suwon-si (KR)

(73) Assignee: SAMSUNG ELECTRO-MECHANICS CO., LTD., Suwon-si, (KR)

(21) Appl. No.: 19/065,619

(22) Filed: Feb. 27, 2025

(30) Foreign Application Priority Data
Sep. 24, 2024 (KR) 10-2024-0128832

(51) Int. Cl. H01G 4/008; H01G 4/30

(52) U.S. Cl. CPC H01G 4/0085; H01G 4/30

(57) ABSTRACT

Provided are a multilayer ceramic capacitor and a method of manufacturing the same, the multilayer ceramic capacitor including a capacitor body including a dielectric layer and an internal electrode layer, and an external electrode disposed on an outer surface of the capacitor body, wherein the internal electrode layer includes a first internal electrode layer and a second internal electrode layer that are stacked and spaced apart from each other with the dielectric layer therebetween, the first internal electrode layer and the second internal electrode layer include one or more elements selected from aluminum (Al), silicon (Si), germanium (Ge), zinc (Zn), tin (Sn), indium (In), and iron (Fe), and the first internal electrode layer and the second internal electrode layer include different elements from each other.

### CROSS-REFERENCE TO RELATED APPLICATION

This application claims priority to and the benefit of Korean Patent Application No. 10-2024-0128832 filed in the Korean Intellectual Property Office on Sep. 24, 2024, the entire contents of which are incorporated herein by reference.

### BACKGROUND OF THE INVENTION

### (a) Field of the Invention

The present disclosure relates to a multilayer ceramic capacitor and a method of manufacturing the same.

### (b) Description of the Related Art

As electronic components using a ceramic material, there are a capacitor, an inductor, a piezoelectric element, a varistor, a thermistor, and the like. Among ceramic electronic components, a multilayer ceramic capacitor (MLCC) may be used in various electronic devices due to advantages such as a small size, a high capacitance, an easy mounting feature, and the like.

For example, a multilayer ceramic capacitor (MLCC) may be used in a chip type condenser mounted on a board of several electronic products such as image devices, for example, liquid crystal displays (LCD), plasma display panels (PDP), or the like, computers, personal portable terminals, smartphones, and the like, to serve to charge or discharge electricity therein or therefrom.

Recently, with the development of electronic devices and autonomous vehicles, miniaturization and high-capacitance multilayer ceramic capacitors are in great demand. To achieve higher capacitance in the same volume, thinning of the internal electrode and dielectric is essential. However, as the dielectric and internal electrodes become thinner, the electric field per unit thickness of the dielectric increases, which may cause a deterioration in the reliability of the multilayer ceramic capacitor.

### SUMMARY OF THE INVENTION

An embodiment provides a multilayer ceramic capacitor having excellent reliability.

Another embodiment provides a method of manufacturing a multilayer ceramic capacitor.

An embodiment provides a multilayer ceramic capacitor including a capacitor body including a dielectric layer and an internal electrode layer, and an outer electrode disposed on an outer surface of the capacitor body, wherein the internal electrode layer includes a first internal electrode layer and a second internal electrode layer that are stacked and spaced apart from each other with the dielectric layer therebetween, the first internal electrode layer and the second internal electrode layer include one or more elements selected from aluminum (Al), silicon (Si), germanium (Ge), zinc (Zn), tin (Sn), indium (In), and iron (Fe), and the first internal electrode layer includes one or more elements that are different from those in the second internal electrode layer.

The first internal electrode layer may include one or more elements (X1) selected from the aluminum (Al), the silicon (Si), and the germanium (Ge), and the second internal electrode layer may include one or more elements (X2) selected from the zinc (Zn), the tin (Sn), the indium (In), and the iron (Fe).

A cathode potential may be applied to the first internal electrode layer, and an anode potential may be applied to the second internal electrode layer.

The first internal electrode layer and the second internal electrode layer may further include nickel (Ni).

The first internal electrode layer may include nickel (Ni) and germanium (Ge), and the second internal electrode layer may include nickel (Ni) and tin (Sn).

The element (X1) of the first internal electrode layer may be included in an amount of about 0.1 parts by weight to about 8 parts by weight based on 100 parts by weight of nickel (Ni).

The element (X2) of the second internal electrode layer may be included in an amount of about 0.1 parts by weight to about 8 parts by weight based on 100 parts by weight of nickel (Ni).

In the first internal electrode layer, a content of the element (X1) may be higher at an interface with the dielectric layer than at a center region of the first internal electrode layer in a stacking direction.

The element (X1) of the first internal electrode layer may be included in a form of an oxide at the interface with the dielectric layer.

In the second internal electrode layer, a content of the element (X2) may be higher at an interface with the dielectric layer than at a center region of the second internal electrode layer in the stacking direction.

The element (X2) of the second internal electrode layer may be included in a form of an oxide at the interface with the dielectric layer.

Another embodiment provides a method for manufacturing a multilayer ceramic capacitor, including: forming a dielectric green sheet using a dielectric slurry; printing a first conductive paste on a surface of a first dielectric green sheet to form a first conductive paste layer and printing a second conductive paste on a surface of a second dielectric green sheet to form a second conductive paste layer; forming a dielectric green sheet stack by alternately stacking the first and second dielectric green sheets; forming a capacitor body including a dielectric layer and an internal electrode layer by firing the dielectric green sheet stack; and forming an external electrode on an outer surface of the capacitor body, wherein the internal electrode layer includes a first internal electrode layer and a second internal electrode layer that are stacked and spaced apart from each other with the dielectric layer therebetween, the first conductive paste and the second conductive paste are prepared from a raw material including one or more metals selected from Al, Si, Ge, Zn, Sn, In, and Fe, an alloy of the metal and Ni, or an oxide of one of the one or more metals, and the first conductive paste is prepared from raw materials different from those of the second conductive paste.

The first conductive paste may be prepared from a raw material including at least one metal (M1) selected from Al, Si, and Ge, an alloy of the metal (M1) and Ni, or an oxide of metal M1, and the second conductive paste may be prepared from a raw material including at least one metal (M2) selected from Zn, Sn, In, and Fe, an alloy of metal M2 and Ni, or an oxide of metal M2.

The first conductive paste and the second conductive paste may be prepared by further including nickel (Ni).

In the raw material of the first conductive paste metal M1 may be included in an amount of about 0.1 parts by weight to about 8 parts by weight based on 100 parts by weight of nickel (Ni).

In the raw material of the second conductive paste metal M2 may be included in an amount of about 0.1 parts by weight to about 8 parts by weight based on 100 parts by weight of nickel (Ni).

A multilayer ceramic capacitor according to an embodiment can improve reliability by preventing deterioration of an interfacial potential barrier between a dielectric layer and an internal electrode layer.

### BRIEF DESCRIPTION OF THE DRAWINGS

FIG. 1 is a perspective view showing a multilayer ceramic capacitor according to an embodiment.

FIG. 2 is a cross-sectional view of the multilayer ceramic capacitor taken along line I-I′ of FIG. 1.

FIG. 3 is a cross-sectional view of the multilayer ceramic capacitor taken along line II-II′ of FIG. 1.

FIG. 4 is an exploded perspective view illustrating the stacked structure of the internal electrode layers in the capacitor body of FIG. 1.

FIG. 5 shows the Ellingham diagram of nickel (Ni), tin (Sn), and germanium (Ge).

FIG. 6 is a SEM-EDS (scanning electron microscope-energy dispersive spectroscopy) analysis image of the first internal electrode layer and the second internal electrode layer according to Example 1.

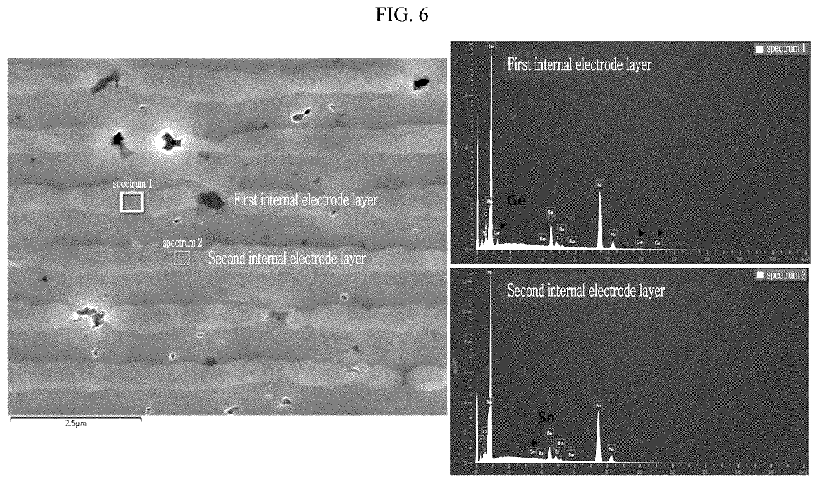

### DETAILED DESCRIPTION OF THE EMBODIMENTS

Hereinafter, the present disclosure will be described in detail hereinafter with reference to the accompanying drawings, in which embodiments of the present disclosure are shown. The drawings and description are to be regarded as illustrative in nature and not restrictive. Like reference numerals designate like elements throughout the specification. In the accompanying drawings, some components are exaggerated, omitted, or schematically illustrated, and the size of each component does not entirely reflect the actual size.

The accompanying drawings are intended only to facilitate an understanding of the embodiments disclosed in this specification, and it is to be understood that the technical ideas disclosed herein are not limited by the accompanying drawings and include all modifications, equivalents, or substitutions that are within the range of the ideas and technology of the present disclosure.

Although terms of “first,” “second,” and the like are used to explain various components, the components are not limited to such terms. These terms are only used to distinguish one component from another component.

In addition, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is referred to as being “on” or “above” a reference element, it can be positioned above or below the reference element, and it is not necessarily referred to as being positioned “on” or “above” in a direction opposite to gravity.

Throughout the specification, the terms “comprise” or “have” are intended to specify the presence of stated features, integers, steps, operations, components, components or a combination thereof, but do not preclude the presence or addition of one or more other features, integers, steps, operations, components, components, and/or groups thereof. Therefore, unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Throughout the specification, the term “connected” does not mean only that two or more constituent components are directly connected, but may also mean that two or more constituent components are indirectly connected through another constituent component, that two or more components are electrically connected as well as physically connected, or that two or more constituent components are referred to by different names but are united by location or function.

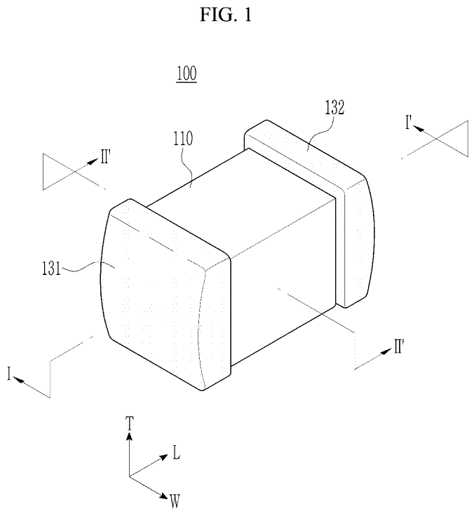

Hereinafter, a multilayer ceramic capacitor according to an embodiment will be described with reference to FIGS. 1 to 4.

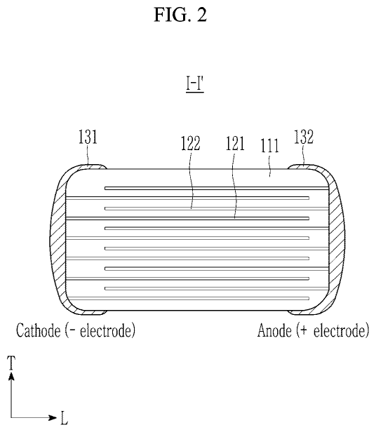

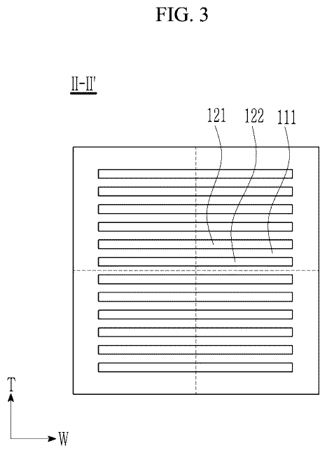

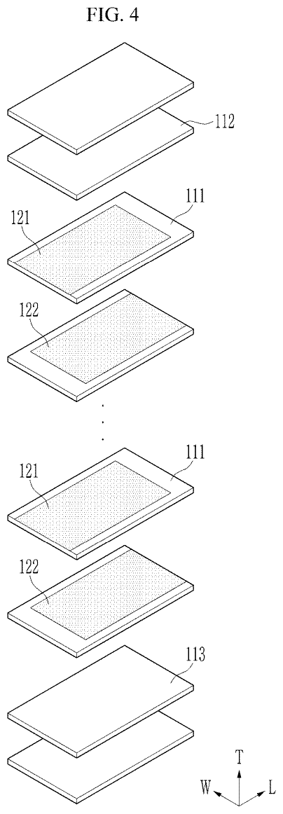

FIG. 1 is a perspective view showing a multilayer ceramic capacitor according to an embodiment, FIG. 2 is a cross-sectional view of a multilayer ceramic capacitor taken along line I-I′ of FIG. 1, FIG. 3 is a cross-sectional view of a multilayer ceramic capacitor taken along line II-II′ of FIG. 1, and FIG. 4 is an exploded perspective view illustrating the stacked structure of the internal electrode layers in the capacitor body of FIG. 1.

The L-axis, W-axis, and T-axis shown in FIGS. 1 to 4 represent a length direction, a width direction, and a thickness direction of a capacitor body 110, respectively. Here, the thickness direction (T-axis direction) may be a direction perpendicular to the wide surface (major surface) of the sheet-shaped components, and may be used as the same concept as a stacking direction in which a dielectric layer 111 are stacked, for example. The length direction (L-axis direction) may be a direction extending parallel to the wide surface (major surface) of the sheet-shaped components, and may be approximately perpendicular to the thickness direction (T-axis direction). For example, the length direction (L-axis direction) may be the direction in which a first external electrode 131 and a second external electrode 132 are positioned. The width direction (W-axis direction) may be a direction extending parallel to the wide surface (major surface) of the sheet-shaped components, and may be approximately perpendicular to the thickness direction (T-axis direction) and the length direction (L-axis direction). The length of the sheet-shaped components in the length direction (L-axis direction) may be longer than the length in the width direction (W-axis direction).

Referring to FIGS. 1 to 4, a multilayer ceramic capacitor 100 according to an embodiment includes the capacitor body 110 and external electrodes 131 and 132 disposed outer surface the capacitor body 110. The external electrodes 131 and 132 may include a first external electrode 131 and a second external electrode 132 disposed at opposite ends of the capacitor body 110 in the length direction (L-axis direction).

For example, the capacitor body 110 may have a roughly hexahedral shape.

For convenience of description of an embodiment, the two surfaces opposing each other in the thickness direction (T-axis direction) of the capacitor body 110 are referred to as first and second surfaces, the two surfaces connected to the first and second surfaces and opposing each other in the length direction (L-axis direction) are referred to as third and the fourth surfaces, and two surfaces connected to the first and second surfaces and to the third and fourth surfaces, and opposing each other in the width direction (W-axis direction) are referred to as the fifth and sixth surfaces.

As an example, the first surface, which is the lower surface, may be a surface facing the mounting direction. Additionally, the first to the sixth surfaces may be flat, but the embodiment is not limited thereto. For example, the first to the sixth surfaces may be curved surfaces with a convex central portion, and the edges, which are the boundaries of each surface, may be rounded.

The shape and size of the capacitor body 110 and the number of stacks of the dielectric layers 111 are not limited to those shown in the drawings of the embodiment.

The capacitor body 110 includes a plurality of dielectric layers 111 and internal electrode layers 121 and 122. Specifically, the internal electrode layers 121 and 122 include a first internal electrode layer 121 and a second internal electrode layer 122 that are spaced apart from each other with a dielectric layer 111 interposed therebetween, that is, alternately arranged in the thickness direction (T-axis direction).

At this time, the boundaries between adjacent dielectric layers 111 of the capacitor body 110 may be integrated to the extent that it is difficult to check without using a scanning electron microscope (SEM).

The capacitor body 110 may include an active region, and cover regions 112 and 113.

The active region is a region where the dielectric layer 111 and the first and second internal electrode layers 121 and 122 are alternately disposed, which contributes to forming capacitance of the multilayer ceramic capacitor 100. Specifically, the active region may be a region where the first internal electrode layer 121 or the second internal electrode layer 122 stacked along the thickness direction (T-axis direction) overlap.

The cover regions 112 and 113 are thickness-direction marginal portions, and may be positioned on the first and second surfaces of the active region in the thickness direction (T-axis direction), respectively. The cover regions 112 and 113 may be a single dielectric layer 111 or two or more dielectric layers 111 stacked on the upper and lower surfaces of the active region, respectively.

Additionally, the capacitor body 110 may further include a side margin region.

The side margin region is a width-direction margin portion and may be located on opposite side ends of the active region in the width direction (W-axis direction), that is, on the fifth surface and the sixth surface, respectively. The side margin region may be formed when the conductive paste layer for the internal electrode is applied on a surface of a dielectric green sheet, the dielectric green sheets, which are applied with the conductive paste layer only in a partial region of the surface of the dielectric green sheet and not applied with the conductive paste layer on both side surfaces of the surface of the dielectric green sheet, are stacked and then fired, but the forming method is not limited thereto.

The cover regions 112 and 113 and the side margin region serve to prevent damage to the first internal electrode layer 121 and the second internal electrode layer 122 due to physical or chemical stress.

Hereinafter, each of the internal electrode layer, dielectric layer, and outer electrode is described in detail.

### Internal Electrode Layer

The first internal electrode layer 121 and the second internal electrode layer 122, are electrodes having different polarities and are alternately arranged to face each other along the T-axis direction with the dielectric layer 111 interposed between them, and one end thereof may be exposed through the third and fourth surfaces of the capacitor body 110, respectively.

The first internal electrode layer 121 and the second internal electrode layer 122 may be electrically insulated from each other by a dielectric layer 111 disposed in the middle.

The ends of the first internal electrode layer 121 and the second internal electrode layer 122, which are alternately exposed through the third and fourth surfaces of the capacitor body 110, may be electrically connected to the first external electrode 131 and the second external electrode 132, respectively.

For example, the first internal electrode layer 121 electrically connected to the first external electrode 131 may be a cathode corresponding to a negative electrode (−electrode) and a cathode potential may be applied to the first internal electrode layer 121, and the second internal electrode layer 122 electrically connected to the second external electrode 132 may be an anode corresponding to a positive electrode (+electrode) and an anode potential may be applied to the second internal electrode layer 122.

According to an embodiment, the first internal electrode layer 121 and the second internal electrode layer 122 may include one or more elements selected from aluminum (Al), silicon (Si), germanium (Ge), zinc (Zn), tin (Sn), indium (In), and iron (Fe). The first internal electrode layer 121 may include elements different from those included in the second internal electrode layer 122.

In general, an interfacial potential barrier is formed at the interface between the dielectric layer and the internal electrode layer, and if the size of this interfacial potential barrier increases, the reliability of the multilayer ceramic capacitor can be improved. One method for evaluating the life-span of a multilayer ceramic capacitor is an accelerated life-span evaluation that applies high temperature and high voltage to both ends of the chip. When voltage is applied to both ends of the chip during an accelerated life-span evaluation, the interfacial potential barrier deteriorates, and if the deterioration becomes severe, a short may occur, causing the multilayer ceramic capacitor to lose its function.

According to an embodiment, when the first internal electrode layer 121 and the second internal electrode layer 122 include different elements, specifically, when they include different elements among Al, Si, Ge, Zn, Sn, In, and Fe, the reliability of the multilayer ceramic capacitor can be improved by preventing deterioration of the interfacial potential barrier formed at the interface between the dielectric layer 111 and the first and second internal electrode layers 121 and 122.

Specifically, the first internal electrode layer 121 to which the cathode potential is applied may include an element that can be oxidized and act as an insulator. That is, the element of the first internal electrode layer 121 may form an insulator with a large band gap energy of the oxide. For example, the first internal electrode layer 121 may include one or more elements (X1) selected from aluminum (Al), silicon (Si), and germanium (Ge), and may include, for example, germanium (Ge). When the first internal electrode layer 121 includes the above element (X1), an oxide layer is formed at the interface between the dielectric layer 111 and the first internal electrode layer 121, thereby preventing the deterioration of the interfacial potential barrier in the cathode direction.

Additionally, the second internal electrode layer 122 to which the anode potential is applied may include an element that can be oxidized and act as an n-type semiconductor. That is, the element of the second internal electrode layer 122 may form an n-type semiconductor having a smaller band gap energy of the oxide than that of the insulator. For example, the second internal electrode layer 122 may include one or more elements (X2) selected from zinc (Zn), tin (Sn), indium (In), and iron (Fe), and may include, for example, tin (Sn). When the second internal electrode layer 122 includes the element (X2), an oxide layer is formed at the interface between the dielectric layer 111 and the second internal electrode layer 122, thereby preventing the deterioration of the interfacial potential barrier in the anode direction.

In other words, when the first internal electrode layer 121 and the second internal electrode layer 122 each include the above elements, an oxide layer of each component is formed at the interface between the dielectric layer and the internal electrode layer during firing, thereby preventing deterioration of the interfacial potential barrier in both the cathode and anode directions. Accordingly, the reliability of the multilayer ceramic capacitor can be improved.

The first internal electrode layer 121 and the second internal electrode layer 122 may further include nickel (Ni).

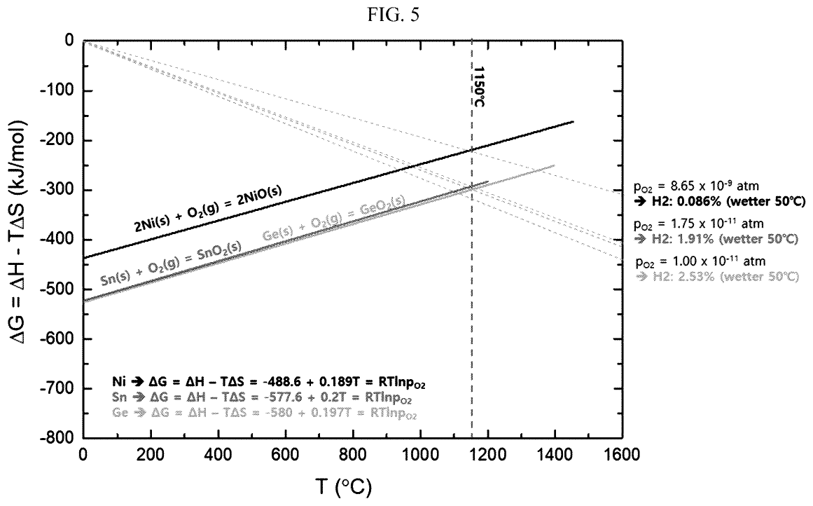

FIG. 5 shows the Ellingham diagram of nickel (Ni), tin (Sn), and germanium (Ge).

Referring to FIG. 5, germanium (Ge) and tin (Sn) are elements that have a stronger oxidation tendency than nickel (Ni). When Ge and Sn are each included in the internal electrode layer, GeO₂ and Ge and SnO₂ and Sn coexist during sintering as Ni acts as a catalyst that promotes the reduction of oxides. Some of these can form a solid solution with Ni within the internal electrode layer, and some can form GeO₂ layers and SnO₂ layers at the interface between the dielectric layer and the internal electrode layer. Both the GeO₂ layer and the SnO₂ layer can increase the potential barrier at the interface between the dielectric layer and the internal electrode layer, thereby improving the reliability of the multilayer ceramic capacitor. Specifically, an n-type semiconductor material such as a SnO₂ layer can improve the reliability of a multilayer ceramic capacitor by preventing deterioration of the potential barrier on the anode side, and an insulator material such as a GeO₂ layer can improve the reliability of a multilayer ceramic capacitor by preventing deterioration of the potential barrier on the cathode side.

For example, the first internal electrode layer 121 may include nickel (Ni) and germanium (Ge). Additionally, the second internal electrode layer 122 may include nickel (Ni) and tin (Sn).

The element (X1) of the first internal electrode layer 121 may be included in an amount of about 0.1 parts by weight to about 8 parts by weight, for example, about 0.2 parts by weight to about 7 parts by weight, about 0.3 parts by weight to about 6 parts by weight, about 0.4 parts by weight to about 5 parts by weight, or about 0.5 parts by weight to about 4 parts by weight based on 100 parts by weight of nickel (Ni). When the content of the element (X1) in the first internal electrode layer is within the above range, deterioration of the interfacial potential barrier between the dielectric layer and the internal electrode layer can be prevented, thereby securing a multilayer ceramic capacitor with excellent reliability.

The element (X2) of the second internal electrode layer may be included in an amount of about 0.1 parts by weight to about 8 parts by weight, for example, about 0.2 parts by weight to about 7 parts by weight, about 0.3 parts by weight to about 6 parts by weight, about 0.4 parts by weight to about 5 parts by weight, or about 0.5 parts by weight to about 4 parts by weight based on 100 parts by weight of nickel (Ni). When the content of the element (X2) in the second internal electrode layer is within the above range, deterioration of the interfacial potential barrier between the dielectric layer and the internal electrode layer can be prevented, thereby securing a multilayer ceramic capacitor with excellent reliability.

The first internal electrode layer 121 and the second internal electrode layer 122 may further include one or more conductive metals selected from copper (Cu), silver (Ag), palladium (Pd), gold (Au), and an alloy thereof, in addition to nickel (Ni).

In the first internal electrode layer 121, the content of the element (X1) may be higher at the interface with the dielectric layer 111 than at the center region of the first internal electrode layer 121 in the stacking direction. When the content of the above element (X1) is higher at the interface between the first internal electrode layer 121 and the dielectric layer 111, the reliability of the multilayer ceramic capacitor can be improved by preventing deterioration of the interfacial potential barrier formed at the interface between the dielectric layer and the internal electrode layer. In the first internal electrode layer 121, the center region is a region located inside the interface between the first internal electrode layer 121 and the dielectric layer 111 in the stacking direction, and the interface with the dielectric layer 111 is a region located outer surface the center region in the stacking direction as the interface between the first internal electrode layer 121 and the dielectric layer 111. Specifically, the interface can be viewed as a region from the interface between the first internal electrode layer 121 and the dielectric layer 111 to a depth of 5 nm inside the first internal electrode layer 121.

The element (X1) of the first internal electrode layer 121 may be included in a form of an oxide at the interface with the dielectric layer 111. In other words, the interface between the first internal electrode layer 121 and the dielectric layer 111 may include an oxide of the element (X1), for example, at least one selected from aluminum oxide (Al₂O₃), silicon dioxide (SiO₂), and germanium oxide (GeO₂).

Additionally, in the second internal electrode layer 122, the content of the element (X2) at the interface with the dielectric layer 111 may be higher than that at the center region of the second internal electrode layer 122 in the stacking direction. When the content of the element (X2) is higher at the interface between the second internal electrode layer 122 and the dielectric layer 111, the reliability of the multilayer ceramic capacitor can be improved by preventing deterioration of the interfacial potential barrier formed at the interface between the dielectric layer and the internal electrode layer. In the second internal electrode layer 122, the center region is a region located inside the interface between the second internal electrode layer 122 and the dielectric layer 111 in the stacking direction, and the interface with the dielectric layer 111 is a region located outside the center region in the stacking direction as the interface between the second internal electrode layer 122 and the dielectric layer 111. Specifically, the interface can be viewed as a region extending from the interface between the second internal electrode layer 122 and the dielectric layer 111 to a depth of 5 nm inside the second internal electrode layer 122.

The element (X2) of the second internal electrode layer 122 may be included in a form of an oxide at the interface with the dielectric layer 111. In other words, the interface between the second internal electrode layer 122 and the dielectric layer 111 may include an oxide of an element (X2), for example, at least one selected from zinc oxide (ZnO), tin oxide (SnO₂), indium oxide (In₂O₃), and iron oxide (FeO, Fe₃O₄, or Fe₂O₃).

Each component and component content in the first internal electrode layer 121 and the second internal electrode layer 122 can be confirmed by SEM-EDS (scanning electron microscope-energy dispersive spectroscopy) analysis.

In more detail, after the multilayer ceramic capacitor 100 was placed into the epoxy mixture liquid and then cured, the L-axis and the T-axis directional surface (LT surface) of the capacitor body 110 was polished to ½ depth in the W-axis direction, and then by fixing and maintaining it in the vacuum atmosphere chamber, a cross-sectional sample may be obtained such that the active region where the dielectric layer 111 and the first and second internal electrode layers 121 and 122 intersect may be observed. Next, the active region of the cross-sectional sample can be measured using a scanning electron microscope (SEM) so that at least two layers of dielectric layers and internal electrode layers are visible, for example, two to ten layers. For example, SEM may be measured under conditions of an acceleration voltage of 2.0 kV in a region of about 8 μm×8 μm in which six dielectric layers and six internal electrode layers are visible in the active region. Next, by performing EDS (energy dispersive spectroscopy) analysis on the first internal electrode layer 121 and the second internal electrode layer 122 through SEM images of the measured cross-sectional samples, the components present in each of the first internal electrode layer 121 and the second internal electrode layer 122 and the contents of these components can be confirmed. For example, the content of each component in the first internal electrode layer and the second internal electrode layer according to an embodiment can be obtained as an average value at a total of 9 points in each of the first internal electrode layer and the second internal electrode layer by dividing the active region of the cross-sectional sample into three equal parts, the upper part, the central part, and the lower part, by marking 3 points in the first internal electrode layer and 3 points in the second internal electrode layer for each region during the EDS point analysis.

Each average thickness of the first internal electrode layer 121 and the second internal electrode layer 122 may be about 0.1 μm to about 2 μm. When the average thickness of the first internal electrode layer 121 and the second internal electrode layer 122 is within the above range, the reliability of the multilayer ceramic capacitor is improved.

As described above, in a scanning electron microscope (SEM) image of a measured cross-sectional sample, the central point in the length direction (L-axis direction) or the width direction (W-axis direction) of the first internal electrode layer 121 or the second internal electrode layer 122 is used as a reference point, and the arithmetic mean value of the thickness of the first internal electrode layer 121 or the second internal electrode layer 122 at 10 points spaced apart from the reference point by a predetermined interval can be obtained. The spacing between the 10 points can be adjusted according to the scale of the scanning electron microscope (SEM) image, and can be, for example, about 1 μm to about 100 μm, about 1 μm to about 50 μm, or about 1 μm to about 10 μm. At this time, all 10 points should be located within the first internal electrode layer 121 or the second internal electrode layer 122, and if all 10 points are not located within the first internal electrode layer 121 or the second internal electrode layer 122, the location of the reference point can be changed or the interval between the 10 points can be adjusted.

### Dielectric Layer

According to an embodiment, the dielectric layer 111 may include a barium titanite-based compound including barium (Ba) and titanium (Ti) as a main component.

The barium titanite-based compound is a dielectric base material, have high permittivity, and contribute to forming the permittivity of multilayer ceramic capacitors 100.

For example, the barium titanite-based compound may include at least one selected from BaTiO₃, Ba(Ti,Zr)O₃, Ba(Ti, Sn)O₃, (Ba, Ca)TiO₃, (Ba, Ca)(Ti, Zr)O₃, (Ba, Ca) (Ti, Sn)O₃, (Ba, Sr)TiO₃, (Ba, Sr) (Ti, Zr)O₃ and (Ba, Sr) (Ti, Sn)O₃.

The dielectric layer 111 may further include a subcomponent. The subcomponent may include one or more selected from, for example, manganese (Mn), chromium (Cr), silicon (Si), aluminum (Al), magnesium (Mg), tin (Sn), antimony (Sb), germanium (Ge), gallium (Ga), indium (In), barium (Ba), lanthanum (La), yttrium (Y), actinium (Ac), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), and vanadium (V).

An average thickness (average length in the T-axis direction) of the dielectric layer 111 may be about 2.0 μm to about 8.0 μm, and for example, may be about 0.1 μm to about 6.0 μm. When the average thickness of the dielectric layer 111 is within the above range, the reliability of the multilayer ceramic capacitor may be improved.

This may be an arithmetic mean value obtained by taking the central point of the length direction (L-axis direction) or width direction (W-axis direction) of the dielectric layer 111 as a reference point in a scanning electron microscope (SEM) image of a cross-sectional sample measured as described above, and taking the arithmetic mean value of the thickness of the dielectric layer 111 at 10 points spaced apart from the reference point at a predetermined interval. The intervals of the 10 points may be adjusted depending on the scale of the SEM image, and may be, for example, about 1 μm to about 100 μm, about 1 μm to about 50 μm, or about 1 μm to about 10 μm. At this time, all 10 points must be positioned within the dielectric layer 111, and if all 10 points are not positioned within the dielectric layer 111, the position of the reference point may be changed, or the interval between the 10 points may be adjusted.

The capacitor body 110 may be formed by firing a stacking structure in which the plurality of dielectric layers 111 and first and second internal electrode layers 121 and 122 are stacked.

### External Electrode

The first external electrode 131 and the second external electrode 132 are provided with voltages of different polarities and may be electrically connected with exposed portions of the first internal electrode layer 121 and the second internal electrode layer 122, respectively.

According to the above configuration, when a predetermined voltage is applied to the first external electrode 131 and the second external electrode 132, charges are accumulated between the first internal electrode layer 121 and the second internal electrode layer 122 facing each other. At this time, the capacitance of the multilayer ceramic capacitor 100 is proportional to the overlapping area of the first internal electrode layer 121 and the second internal electrode layer 122 that overlap each other along the T-axis direction in the active region.

The first external electrode 131 and the second external electrode 132 may include, respectively, first and second connection portions disposed on the third and fourth surfaces of the capacitor body 110 and connected to the first internal electrode layer 121 and the second internal electrode layer 122, and first and second band portions disposed on edges where the third and fourth surfaces of the capacitor body 110 meet the first and second surfaces or the fifth and sixth surfaces.

The first and second band portions may extend, respectively, from the first and second connection portions to portions of the first and second surfaces of the capacitor body 110 or the fifth and sixth surfaces. The first and second band portions may serve to improve the adhesion strength of the first external electrode 131 and the second external electrode 132.

Each of the first external electrode 131 and the second external electrode 132 may include a sintered metal layer in contact with the capacitor body 110, a conductive resin layer disposed to cover the sintered metal layer, and a plating layer disposed to cover the conductive resin layer.

The sintered metal layer may include the conductive metal and glass.

The conductive metal may include one or more selected from copper (Cu), nickel (Ni), silver (Ag), palladium (Pd), gold (Au), platinum (Pt), tin (Sn), tungsten (W), titanium (Ti), lead (Pb), and an alloy thereof, for example, copper (Cu) may include a copper (Cu) alloy. When the conductive metal includes copper (Cu), metals other than copper (Cu) may be included in an amount of less than or equal to about 5 parts by mole based on 100 parts by mole of copper (Cu).

The glass may include a composition of mixed oxides, for example, one or more selected from the group consisting of silicon oxide, boron oxide, aluminum oxide, transition metal oxide, alkali metal oxide, and alkaline earth metal oxide. The transition metal may be selected from a group consisting of zinc (Zn), titanium (Ti), copper (Cu), vanadium (V), manganese (Mn), iron (Fe) and nickel (Ni), the alkali metal may be selected from a group consisting of lithium (Li), sodium (Na) and potassium (K), and the alkaline-earth metal may be at least one selected from a group consisting of magnesium (Mg), calcium (Ca), strontium (Sr) and barium (Ba).

Optionally, the conductive resin layer may be formed on the sintered metal layer, and for example, may be formed in the shape that completely covers the sintered metal layer. Meanwhile, the first external electrode 131 and the second external electrode 132 may not include the sintered metal layer, and in this case, the conductive resin layer may directly contact the capacitor body 110.

The conductive resin layer extends to the first and second surfaces or the fifth and sixth surfaces of the capacitor body 110, and the length of the region (i. e., band portion) where the conductive resin layer is extended and disposed to the first and second surfaces or the fifth and sixth surfaces of the capacitor body 110 may be longer than the length of the region (i. e., band portion) where the sintered metal layer is extended and disposed to the first and second surfaces or the fifth and sixth surfaces of the capacitor body 110. That is, the conductive resin layer may be formed on the sintered metal layer, and may be formed in the shape that completely covers the sintered metal layer.

The conductive resin layer may include a resin and a conductive metal.

The resin included in the conductive resin layer may be implemented by a material which has adhesive properties and shock absorption properties and is able to form a paste when mixed with the conductive metal powder, but is not limited thereto. For example, the resin may include a phenolic resin, an acrylic resin, a silicone resin, an epoxy resin, or a polyimide resin.

The conductive metal included in the conductive resin layer serves to be electrically connected to the first internal electrode layer 121 and the second internal electrode layer 122 or the sintered metal layer.

The conductive metal included in the conductive resin layer may have a spherical shape, a flake shape, or a combination thereof. That is, the conductive metal may be formed only in flake form, only in spherical form, or in a mixed form of flake form and spherical form.

Here, the spherical shape may also include a shape that is not a perfect spherical shape, for example, a shape in which the length ratio of the major axis and the minor axis (major axis/minor axis) is less than or equal to about 1.45. The flake shape powder refers to a powder with a flat and elongated shape, and is not particularly limited. But for example, the length ratio of the major axis and the minor axis (major axis/minor axis) may be greater than or equal to about 1.95.

The first external electrode 131 and the second external electrode 132 may further include the plating layer disposed outer surface the conductive resin layer.

The plating layer may include nickel (Ni), copper (Cu), tin (Sn), palladium (Pd), platinum (Pt), gold (Au), silver (Ag), tungsten (W), titanium (Ti), or lead (Pb), either alone or in an alloy thereof. For example, the plating layer may be a nickel (Ni) the plating layer or a tin (Sn) the plating layer, may be a form in which the nickel (Ni) the plating layer and the tin (Sn) the plating layer are sequentially stacked, or may be a form in which the tin (Sn) the plating layer, the nickel (Ni) the plating layer, and the tin (Sn) the plating layer are sequentially stacked. In addition, the plating layer may include a plurality of nickel (Ni) the plating layers and/or a plurality of tin (Sn) the plating layers.

The plating layer may improve mountability to the substrate, structural reliability, durability to the outside, heat resistance, and equivalent series resistance (ESR) of the multilayer ceramic capacitor 100.

### Method for Manufacturing Multilayer Ceramic Capacitor

Hereinafter, a method of manufacturing the multilayer ceramic capacitor 100 according to an embodiment will be described.

A multilayer ceramic capacitor 100 according to an embodiment may be manufactured by the processes of forming a dielectric green sheet using a dielectric slurry; printing a first conductive paste on a surface of a first dielectric green sheet to form a first conductive paste layer and printing a second conductive paste on a surface of a second dielectric green sheet to form a second conductive paste layer; manufacturing a dielectric green sheet stack by alternately stacking the first and second dielectric green sheets; forming a capacitor body including a dielectric layer and an internal electrode layer by firing the dielectric green sheet stack; and forming an external electrode on an outer surface of the capacitor body.

The first conductive paste and the second conductive paste can be prepared from a raw material including one or more metals selected from Al, Si, Ge, Zn, Sn, In, and Fe, an alloy of the metal and Ni, or an oxide of the metal. At this time, the first conductive paste and the second conductive paste may be prepared from different raw materials.

Specifically, the first conductive paste may be prepared from a raw material including one or more metals (M1) selected from Al, Si and Ge, an alloy of the metal (M1) and Ni, or an oxide of the metal (M1). Additionally, the second conductive paste may be prepared from a raw material including one or more metals (M2) selected from Zn, Sn, In, and Fe, an alloy of the metal (M2) and Ni, or an oxide of the metal (M2).

When the first and second conductive pastes are prepared using the above-described respective components to form the first and second internal electrode layers, a multilayer ceramic capacitor having excellent reliability can be obtained by preventing deterioration of the interfacial potential barrier between the dielectric layer and the internal electrode layer.

The first conductive paste and the second conductive paste may be prepared by further including nickel (Ni).

The raw material of the first conductive paste may be included such that the metal (M1) may be in an amount of about 0.1 parts by weight to about 8 parts by weight, for example, about 0.2 parts by weight to about 7 parts by weight, about 0.3 parts by weight to about 6 parts by weight, about 0.4 parts by weight to about 5 parts by weight, or about 0.5 parts by weight to about 4 parts by weight based on 100 parts by weight of nickel (Ni).

In addition, the raw material of the second conductive paste may be included such that the metal (M2) may be in an amount of about 0.1 parts by weight to about 8 parts by weight, for example, about 0.2 parts by weight to about 7 parts by weight, about 0.3 parts by weight to about 6 parts by weight, about 0.4 parts by weight to about 5 parts by weight, or about 0.5 parts by weight to about 4 parts by weight based on 100 parts by weight of nickel (Ni).

When the raw materials of the first conductive paste and the raw materials of the second conductive paste are mixed within the above content ranges, a multilayer ceramic capacitor having excellent reliability can be obtained by preventing deterioration of the interfacial potential barrier between the dielectric layer and the internal electrode layer.

The first conductive paste and the second conductive paste may further include, in addition to nickel (Ni), one or more conductive metals selected from copper (Cu), silver (Ag), palladium (Pd), gold (Au), and an alloy thereof.

The first conductive paste and the second conductive paste may be prepared by additionally mixing a binder and a solvent. Additionally, barium titanate-based powder may be mixed in as a co-material if necessary. The co-material may act to inhibit the sintering of the conductive powder during the firing process.

A dielectric slurry may be prepared by mixing a barium titanate-based compound as a main component powder and optionally a subcomponent powder.

The barium titanite-based compound may include at least one selected from BaTiO₃, Ba(Ti, Zr)O₃, Ba(Ti, Sn)O₃, (Ba, Ca)TiO₃, (Ba, Ca)(Ti, Zr)O₃, (Ba, Ca) (Ti, Sn)O₃, (Ba, Sr)TiO₃, (Ba, Sr)(Ti, Zr)O₃, and (Ba, Sr)(Ti, Sn)O₃.

The subcomponent powder may be one or more oxide or salt compounds selected from, for example, Mn, Cr, Si, Al, Mg, Sn, Sb, Ge, Ga, In, Ba, La, Y, Ac, Pr, Nd, Pm, Sm, Eu, Gd, Tb, Dy, Ho, Er, Tm, Yb, Lu, Hf and V, or may be used in a form of a sol dispersed in an organic solvent.

In addition, the dielectric slurry may be prepared by additionally mixing additives such as a dispersant, a binder, a plasticizer, a lubricant, an antistatic agent, and a solvent.

The dispersant may include at least one selected from, for example, a phosphoric acid ester-based dispersant and a polycarboxylic acid-based dispersant. The dispersant may be mixed in an amount of about 0.1 part by weight to about 5 parts by weight, for example, about 0.3 parts by weight to about 3 parts by weight based on 100 parts by weight of the barium titanite-based compound. When the dispersant is mixed within the above content range, the dielectric slurry shows excellent dispersibility, and the amount of impurities included in the manufactured dielectric layer may be reduced.

The binder may be, for example, an acrylic resin, a polyvinyl butyl resin, a polyvinyl acetal resin, an ethylcellulose resin, or the like. The binder may be added in an amount of about 0.1 part by weight to about 50 parts by weight, for example, about 3 parts by weight to about 30 parts by weight, based on 100 parts by weight of the barium titanate-based compound. When the binder is mixed within the above content range, the dielectric slurry shows excellent dispersibility, and the amount of impurities included in the manufactured dielectric layer may be reduced.

The plasticizer may be, for example, a phthalic acid-based compound such as dioctyl phthalate, benzyl butyl phthalate, dibutyl phthalate, dihexyl phthalate, di(2-ethylhexyl) phthalate, and di(2-ethylbutyl) phthalate; an adipic acid-based compound such as dihexyl adipate and di(2-ethylhexyl) adipate; a glycol-based compound such as ethylene glycol, diethylene glycol, and triethylene glycol; a glycol ester-based compound such as triethylene glycol dibutyrate, triethylene glycol di(2-ethylbutyrate), and triethylene glycol di(2-ethylhexanoate); and the like. The plasticizer may be added in an amount of about 0.1 part by weight to about 20 parts by weight, for example, about 1 part by weight to about 10 parts by weight, based on 100 parts by weight of the barium titanite-based compound. When the plasticizer is mixed within the above content range, the dielectric slurry shows excellent dispersibility, and the amount of impurities included in the manufactured dielectric layer may be reduced.

The solvent may be an aqueous solvent such as water; an alcohol-based solvent such as ethanol, methanol, benzyl alcohol, and methoxyethanol; a glycol-based solvent such as ethylene glycol and diethylene glycol; a ketone-based solvent such as acetone, methyl ethyl ketone, methyl isobutyl ketone, and cyclohexanone; an ester-based solvent such as butyl acetate, ethyl acetate, carbitol acetate, and butylcarbitol acetate; an ether-based solvent such as methyl cellosolve, ethyl cellosolve, butyl ether, and tetrahydrofuran; an aromatic-based solvent such as benzene, toluene, and xylene, or the like. The solvent may be, for example, an alcohol-based solvent or aromatic-based solvent, considering solubility or dispersibility of various additives included in the dielectric slurry. The solvent may be mixed in an amount of about 50 parts by weight to about 1000 parts by weight, and for example, about 100 parts by weight to about 500 parts by weight based on 100 parts by weight of the barium titanate-based compound. When the solvent is mixed within the above content range, the dielectric slurry components may be sufficiently mixed, and subsequent removal of the solvent is easy.

The dielectric slurry described above may be mixed by using a wet ball mill or a stirred mill. When using the zirconia balls in the wet ball mill, a plurality of zirconia balls with a diameter of about 0.1 mm to about 10 mm may be used for wet mixing for about 8 hours to about 48 hours, or about 10 hours to about 24 hours.

The prepared dielectric slurry is formed into a dielectric layer after firing. As a method of molding the prepared the dielectric slurry into a sheet shape, a tape molding method such as a doctor blade method, a calendar roll method, etc. may be used, for example, an on-roll molding coater with a head discharge method, and a dielectric green sheet may be obtained by drying the molded body afterward.

In the step of manufacturing the dielectric green sheet, a dielectric slurry may be prepared by mixing a barium titanate-based compound as a main component powder and optionally a subcomponent powder.

Next, a dielectric green sheet stack is manufactured by stacking a plurality of layers of dielectric green sheets on which internal electrode patterns are formed, and then pressing the plurality of layers of dielectric green sheets in the stacking direction. At this time, the dielectric green sheet and the internal electrode pattern may be stacked so that the dielectric green sheet is positioned on the upper and lower surfaces of the dielectric green sheet stack in the stacking direction.

The cutting of the manufactured dielectric green sheet stack to a predetermined size by dicing or the like may optionally be performed.

Additionally, the dielectric green sheet stack may be solidified and dried to remove plasticizers, etc., if necessary, and after solidified and dried, the dielectric green sheet stack may be barrel polished using a horizontal centrifugal barrel machine, and the like. In barrel polishing, the dielectric green sheet stack is placed into a barrel container with media and polishing liquid, and rotational motion or vibration is applied to the barrel container, thus unnecessary parts, such as burrs generated during cutting, may be polished. Additionally, after barrel polishing, the dielectric green sheet stack may be washed with a cleaning solution such as water, and dried.

Subsequently, the capacitor body may be prepared after binder removal treatment (calcining) and firing of the dielectric green sheet stack.

The conditions for binder removal may be appropriately adjusted depending on the components of the dielectric layer or the internal electrode layer. For example, the rate of temperature rise during binder removal treatment may be about 5° C./hour to about 300° C./hour, the support temperature may be about 180° C. to about 400° C., and the temperature holding time may be about 0.5 hour to about 24 hours. The binder removal may be performed under an air atmosphere or a reducing atmosphere.

The conditions of the firing treatment may be appropriately adjusted depending on the main component composition of the dielectric layer or the main component composition of the internal electrode layer. For example, the firing may be performed at a temperature of about 1100° C. to about 1400° C., for example, at a temperature of about 1200° C. to about 1350° C. Additionally, the firing may be performed for about 0.5 to about 8 hours, for example, about 1 to about 3 hours. Additionally, the firing may be performed in a reducing atmosphere, for example, in a humidified mixed gas of nitrogen and hydrogen, and may be performed under conditions such as a hydrogen concentration of less than or equal to about 1.0%. When the internal electrode layer includes nickel (Ni) or a nickel (Ni) alloy, an oxygen partial pressure under the firing atmosphere may be about 1.0×10⁻¹⁴ MPa to about 1.0×10⁻¹⁰ MPa.

After firing, annealing may be performed as needed. The annealing is a treatment to re-oxidize the dielectric layer, and annealing may be performed if firing is performed in a reducing atmosphere. The conditions of the annealing treatment may also be appropriately adjusted depending on the components of the dielectric layer. For example, the annealing temperature may be about 950° C. to about 1150° C., the time may be about 0 to about 20 hours, and the rate of temperature rise may be about 50° C./hour to about 500° C./hour. The annealing atmosphere may be a humidified nitrogen gas (N₂) atmosphere, and an oxygen partial pressure may be about 1.0×10⁻⁹ MPa to about 1.0×10⁻⁵ MPa.

In binder removal treatment, firing treatment, or annealing treatment, for example, a wetter may be used to humidify nitrogen gas or mixed gas. In this case, the water temperature may be about 5° C. to about 75° C. The binder removal treatment, firing treatment, and annealing treatment may be performed sequentially or independently.

Optionally, surface treatment such as sand blasting, laser irradiation, barrel polishing, etc. may be performed on the third and fourth surfaces of the prepare capacitor body 110. By performing this surface treatment, the ends of the first internal electrode layer and the second internal electrode layer may be exposed to the outermost surfaces of the third and fourth surfaces, and thus the electrical connection between the first external electrode layer and the second external electrode layer, and the first internal electrode and the second internal electrode may be improved, alloy portions may be easily formed.

Subsequently, the external electrode is formed on the one surface of the manufactured capacitor body 110.

As an example, a paste for forming the sintered metal layer may be applied to the external electrode and then sintered to form the sintered metal layer.

The paste for forming the sintered metal layer may include the conductive metal and glass. Since the description of the conductive metal and glass is the same as described above, repetitive description will be omitted. Additionally, the paste for forming the sintered metal layer may optionally include a binder, solvent, dispersant, plasticizer, oxide powder, and the like. The binder may be, for example, ethylcellulose, acrylic, butyral, etc., and the solvent may be, for example, an organic solvent or aqueous solvent such as terpineol, butylcarbitol, alcohol, methyl ethyl ketone, acetone, toluene, and the like.

Methods for applying the paste for forming the sintered metal layer on the outer surface of the capacitor body 110 may include various printing methods such as dip method and screen printing, application method using a dispenser, etc., and spraying method using spray. The paste for forming the sintered metal layer may be applied to at least the third and fourth surfaces of the capacitor body 110, and optionally applied to a part of the first, second, fifth, or the sixth surfaces on which the band portions of the first and second external electrodes are formed.

Thereafter, the capacitor body 110 applied with the paste for forming the sintered metal layer is dried, and sintered at a temperature of about 700° C. to about 1000° C. for about 0.1 hour to about 3 hours, to form the sintered metal layer.

Optionally, a paste for forming the conductive resin layer is applied on an outer surface of the obtained capacitor body 110 and then cured, to form the conductive resin layer.

The paste for forming the conductive resin layer may include a resin and, optionally, a conductive metal or a non-conductive filler. Since the description of the conductive metal and resin is the same as described above, repetitive description will be omitted. Additionally, the paste for forming the conductive resin layer may optionally include a binder, a solvent, a dispersant, a plasticizer, an oxide powder, and the like. The binder may be, for example, ethylcellulose, acrylic, butyral, etc., and the solvent may be an organic solvent or aqueous solvent such as terpineol, butylcarbitol, alcohol, methyl ethyl ketone, acetone, and toluene.

For example, the conductive resin layer may be formed by dipping the capacitor body 110 in the paste for forming the conductive resin layer and then curing it, or by printing the paste for forming the conductive resin layer on the surface of the capacitor body 110 by a screen-printing method or a gravure printing method, or by applying the paste for forming the conductive resin layer to the surface of the capacitor body 110 and then curing it.

Next, the plating layer is formed on the outer surface of the conductive resin layer.

For example, the plating layer may be formed by a plating method, sputtering, or electrolytic plating (electric deposition).

Hereinafter, the embodiments are illustrated in more detail with reference to examples. However, these examples are exemplary, and the scope of claims is not limited thereto.

### (Manufacturing of Multilayer Ceramic Capacitors)

### Example 1

A first conductive paste was prepared by mixing nickel (Ni) and germanium oxide (GeO₂). At this time, GeO₂ was mixed such that Ge was included in an amount of 0.72 parts by weight based on 100 parts by weight of Ni.

Additionally, a second conductive paste was prepared by mixing nickel (Ni) and tin oxide (SnO₂). At this time, SnO₂ was mixed such that Sn was included in an amount of 0.52 parts by weight of Sn based on 100 parts by weight of Ni.

Next, a dielectric slurry was prepared using barium titanate (BaTiO₃) powder. At this time, the dielectric slurry was prepared by mechanical milling after adding ethanol/toluene, a dispersant, and a binder together using zirconia balls (ZrO₂ balls) as a dispersion medium.

Subsequently, the prepared dielectric slurry was used to manufacture a dielectric green sheet by using a head discharge type on-roll forming coater. On the surface of the dielectric green sheet, the first conductive paste was printed to form a first conductive paste layer, and on the other surface of the dielectric green sheet, the second conductive paste was printed to form a second conductive paste layer. A dielectric green sheet stack was manufactured by alternately laminating and pressing a dielectric green sheet on which a first conductive paste layer was formed and a dielectric green sheet on which a second conductive paste layer was formed.

The dielectric green sheet stack was calcinated at 400° C. or less under a nitrogen atmosphere and fired at 1300° C. or less at a hydrogen (H₂) concentration of 1.0% or less.

Subsequently, the dielectric green sheet stack was used to manufacture a multilayer ceramic capacitor through processes of an external electrode, plating, or the like.

### Example 2

A multilayer ceramic capacitor was manufactured in the same manner as in Example 1 except that the first conductive paste was prepared by mixing GeO₂ in an amount of 1.21 parts by weight of Ge based on 100 parts by weight of Ni, and the second conductive paste was prepared by mixing SnO₂ in an amount of 0.44 parts by weight of Sn based on 100 parts by weight of Ni.

### Example 3

A multilayer ceramic capacitor was manufactured in the same manner as in Example 1 except that the first conductive paste was prepared by mixing GeO₂ in an amount of 0.89 parts by weight of Ge based on 100 parts by weight of Ni, and the second conductive paste was prepared by mixing SnO₂ in an amount of 0.79 parts by weight of Sn based on 100 parts by weight of Ni.

### Example 4

A multilayer ceramic capacitor was manufactured in the same manner as in Example 1 except that the first conductive paste was prepared by mixing GeO₂ in an amount of 1.1 parts by weight of Ge based on 100 parts by weight of Ni, and the second conductive paste was prepared by mixing SnO₂ in an amount of 1.2 parts by weight of Sn based on 100 parts by weight of Ni.

### Comparative Example 1

A multilayer ceramic capacitor was manufactured in the same manner as in Example 1 except that the first conductive paste and the second conductive paste were all made of Ni.

### Comparative Example 2

A multilayer ceramic capacitor was manufactured in the same manner as in Example 1 except that the first conductive paste and the second conductive paste were all prepared by mixing Ni and GeO₂. Herein, GeO₂ was mixed to have 1.25 parts by weight of Ge based on 100 parts by weight of Ni.

### Comparative Example 3

A multilayer ceramic capacitor was manufactured in the same manner as in Example 1 except that the first conductive paste and the second conductive paste were prepared by mixing Ni and SnO₂. Herein, SnO₂ was mixed to have 0.95 parts by weight of Sn based on 100 parts by weight of Ni.

### Evaluation 1: SEM-EDS Line Analysis

The multilayer ceramic capacitors according to Examples 1 to 4 and Comparative Examples 1 to 3 were subjected to SEM-EDS (scanning electron microscope-energy dispersive spectroscopy) analysis, and the results are shown in Table 1 and FIG. 7.

Specifically, after the multilayer ceramic capacitor of Example 1 was put in an epoxy mixture and cured, the L-axis and T-axis direction surface (LT surface) of its capacitor body was polished to a ½ depth in a W-axis direction and then, fixed and maintained in a vacuum atmosphere chamber, obtaining a cross-sectional sample to examine an active region where a dielectric layer and an internal electrode layer intersect each other. Subsequently, the active region of the cross-sectional sample was measured with a scanning electron microscope (SEM). The SEM measurement was performed in an area of about 8 μm×8 μm where at least 6 dielectric layers and internal electrode layers are visible in the active region at an acceleration voltage of 2.0 kV. Subsequently, the SEM image of the cross-sectional sample was used to perform an EDS (energy dispersive spectroscopy) analysis of the first internal electrode layer and the second internal electrode layer to check components and contents of the components in the first internal electrode layer and the second internal electrode layer. Specifically, the active region of the cross-sectional sample was divided into three parts of upper, central, and lower parts, 3 points per each part were marked respectively in first internal electrode layer and the second internal electrode layer to obtain an average value of the component contents at a total of 9 points in each of the first internal electrode layer and the second internal electrode layer.

FIG. 7 is a SEM-EDS (scanning electron microscope-energy dispersive spectroscopy) analysis image of the first internal electrode layer and the second internal electrode layer according to Example 1.

Referring to FIG. 7, Example 1 was confirmed to have nickel (Ni) and germanium (Ge) in the first internal electrode layer and nickel (Ni) and tin (Sn) in the second internal electrode layer.

In Table 1, a content of Ge was expressed based on 100 parts by weight of Ni in the first internal electrode layer or the second internal electrode layer, and a content of Sn was expressed based on 100 parts by weight of Ni in the first internal electrode layer or the second internal electrode layer.

TABLE 1

| | First internal electrode layer | | Second internal electrode layer | |
|---|---|---|---|---|
| | Ge (parts | Sn (parts | Ge (parts | Sn (parts |
| | by weight) | by weight) | by weight) | by weight) |
| Example 1 | 0.72 | — | — | 0.52 |
| Example 2 | 1.21 | — | — | 0.44 |
| Example 3 | 0.89 | — | — | 0.79 |
| Example 4 | 1.1 | — | — | 1.2 |
| Comparative | — | — | — | — |
| Example 1 | | | | |
| Comparative | 1.25 | — | 1.25 | — |
| Example 2 | | | | |
| Comparative | — | 0.95 | — | 0.95 |
| Example 3 | | | | |

Referring to Table 1 and FIG. 7, the multilayer ceramic capacitor according to an embodiment was confirmed to have first and second internal electrode layers including different components.

### Evaluation 2: Reliability

The multilayer ceramic capacitors according to Examples 1 to 4 and Comparative Examples 1 to 3 were measured with respect to mean time to failure (MTTF), and the results are shown in Table 2.

MTTF (mean time to failure) was obtained as hours (hr) at a voltage of 8 V for 72 hours at a temperature of 125° C.

In Table 2, MTTF was expressed as a ratio relative to the result of Comparative Example 1.

### Evaluation 3: Degradation of Interfacial Potential Barrier

The multilayer ceramic capacitors according to Examples 1 to 4 and Comparative Examples 1 to 3 were subjected to KPFM (kelvin probe force microscope) analysis in order to evaluate deterioration of interfacial potential barrier between dielectric layer and internal electrode layer, and the results are shown in Table 2.

Specifically, in order to measure changes of the interfacial potential barrier before and after evaluating MTTF (mean time to failure), the multilayer ceramic capacitors according to Examples 1 to 4 and Comparative Examples 1 to 3 were deteriorated at a temperature of 125° C. for 72 hours at a voltage of 8 V for 72 hours to prepare samples. The multilayer ceramic capacitor samples were polished on the L-axis and T-axis direction surface (LT surface) of each capacitor body to a ½ depth in a W-axis direction to prepare the samples with an LT cross-section exposed. Subsequently, a central part of the active region of each of the cross-sectional samples was subjected to KPFM (kelvin probe force microscope) analysis. The KPFM analysis was performed by using Park systems NX-10 equipment to apply a voltage of 1 V to an area of about 5 μm×5 μm in the central part. A surface potential (V) obtained from the KPFM analysis was differentiated in an x direction to calculate a degradation degree of the interfacial potential barrier.

TABLE 2

| | | Degradation of interfacial potential barrier | |
|---|---|---|---|
| | MTTF | cathode | anode |
| Comparative | 1 | −17.9% | −9.0% |
| Example 1 | | | |
| Comparative | 2.33 | −3.9% | −14.3% |
| Example 2 | | | |
| Comparative | 2.24 | −11.0% | −5.5% |
| Example 3 | | | |
| Example 1 | 2.78 | −2.4% | −3.7% |
| Example 2 | 2.95 | 1.2% | −3.1% |
| Example 3 | 3.01 | −0.5% | −4.7% |
| Example 4 | 3.22 | −1.9% | −1.7% |

Referring to Table 2, Examples 1 to 4, compared with Comparative Examples 1 to 3, exhibited a low degradation degree of the interfacial potential barrier between dielectric layer and internal electrode layer and thus excellent reliability. Accordingly, the first internal electrode layer and the second internal electrode layer, which included different elements each other according to an embodiment, were confirmed to prevent the degradation of the interfacial potential barrier, providing a multilayer ceramic capacitor with improved reliability.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

100: multilayer ceramic capacitor
110: capacitor body
111: dielectric layer
121: first internal electrode layer
122: second internal electrode layer
131: first external electrode
132: second external electrode

What is claimed is:

1. A multilayer ceramic capacitor, comprising:
a capacitor body including a dielectric layer and an internal electrode layer, and
an external electrode disposed on an outer surface of the capacitor body,
wherein the internal electrode layer includes a first internal electrode layer and a second internal electrode layer that are stacked in a stacking direction and spaced apart from each other with the dielectric layer therebetween, and
the first internal electrode layer and the second internal electrode layer include one or more elements selected from aluminum (Al), silicon (Si), germanium (Ge), zinc (Zn), tin (Sn), indium (In), and iron (Fe), the first internal electrode layer includes one or more elements that are different from those in the second internal electrode layer.

2. The multilayer ceramic capacitor of claim 1, wherein
the first internal electrode layer includes one or more elements (X1) selected from aluminum (Al), silicon (Si), and germanium (Ge), and
the second internal electrode layer includes one or more elements (X2) selected from zinc (Zn), tin (Sn), indium (In), and iron (Fe).

3. The multilayer ceramic capacitor of claim 2, wherein
a cathode potential is applied to the first internal electrode layer, and
an anode potential is applied to the second internal electrode layer.

4. The multilayer ceramic capacitor of claim 2, wherein
the first internal electrode layer and second internal electrode layer further include nickel (Ni).

5. The multilayer ceramic capacitor of claim 4, wherein
the first internal electrode layer includes the nickel (Ni) and the germanium (Ge), and
the second internal electrode layer includes the nickel (Ni) and the tin (Sn).

6. The multilayer ceramic capacitor of claim 4, wherein
element X1 of the first internal electrode layer is included in an amount of 0.1 parts by weight to 8 parts by weight based on 100 parts by weight of nickel (Ni).

7. The multilayer ceramic capacitor of claim 4, wherein
element X2 of the second internal electrode layer is included in an amount of 0.1 parts by weight to 8 parts by weight based on 100 parts by weight of nickel (Ni).

8. The multilayer ceramic capacitor of claim 2, wherein
in the first internal electrode layer, a content of element X1 is higher at an interface with the dielectric layer than at a center region of the first internal electrode layer in the stacking direction.

9. The multilayer ceramic capacitor of claim 8, wherein
element X1 of the first internal electrode layer is included in a form of an oxide at the interface with the dielectric layer.

10. The multilayer ceramic capacitor of claim 2, wherein
in the second internal electrode layer, a content of element X2 is higher at an interface with the dielectric layer than at a center region of the second internal electrode layer in the stacking direction.

11. The multilayer ceramic capacitor of claim 10, wherein
element X2 of the second internal electrode layer is included in a form of an oxide at the interface with the dielectric layer.

12. A method for manufacturing a multilayer ceramic capacitor, comprising:
forming a dielectric green sheet using a dielectric slurry;
printing a first conductive paste on a surface of a first dielectric green sheet to form a first conductive paste layer and printing a second conductive paste on a surface of a second dielectric green sheet to form a second conductive paste layer;
forming a dielectric green sheet stack by alternately stacking the first and second dielectric green sheets;
forming a capacitor body including a dielectric layer and an internal electrode layer by firing the dielectric green sheet stack; and
forming an external electrode on an outer surface of the capacitor body,
wherein the internal electrode layer includes a first internal electrode layer and a second internal electrode layer that are stacked and spaced apart from each other with the dielectric layer therebetween,
wherein the first conductive paste and the second conductive paste are prepared from a raw material including one or more metals selected from Al, Si, Ge, Zn, Sn, In, and Fe, an alloy of thereof and Ni, or an oxide of one of the one or more metals, and
wherein the first conductive paste and the second conductive paste are prepared from different raw materials.

13. The method of claim 12, wherein
the first conductive paste is prepared from a raw material including at least one metal (M1) selected from Al, Si, and Ge, an alloy of the metal (M1) and Ni, or an oxide of metal M1, and
the second conductive paste is prepared from a raw material including at least one metal (M2) selected from Zn, Sn, In, and Fe, an alloy of metal M2 and Ni, or an oxide of metal M2.

14. The method of claim 13, wherein
the first conductive paste and the second conductive paste are prepared by further including nickel (Ni).

15. The method of claim 13, wherein
in the raw material of the first conductive paste metal M1 is included in an amount of 0.1 parts by weight to 8 parts by weight based on 100 parts by weight of nickel (Ni).

16. The method of claim 13, wherein
in the raw material of the second conductive paste metal M2 is included in an amount of 0.1 parts by weight to 8 parts by weight based on 100 parts by weight of nickel (Ni).

17. A multilayer ceramic capacitor, comprising:
a cathodic internal electrode comprising one or more metals (M1) having an insulating oxide;
a dielectric layer disposed on a surface of the cathodic internal electrode; and
an anodic internal electrode comprising one or more metals (M2) having an oxide that is an n-type semiconductor, M2 being different from M1, the anodic internal electrode being disposed on the dielectric layer such that the dielectric layer is disposed between the anodic and cathodic internal electrodes.

18. The multilayer ceramic capacitor of claim 17, wherein M1 is selected from the group consisting of AI, Si, and Ge.

19. The multilayer ceramic capacitor of claim 17, wherein M2 is selected from the group consisting of Zn, Sn, In, and Fe.

20. The multilayer ceramic capacitor of claim 17, wherein the cathodic and anodic internal electrodes further comprise Ni.

21. The multilayer ceramic capacitor of claim 20, wherein a content of M1 in the cathodic internal electrode is in a range from 0.1 parts to 8.0 parts by weight based on 100 parts by weight of Ni.

22. The multilayer ceramic capacitor of claim 20, wherein a content of M2 in the anodic internal electrode is in a range from 0.1 parts to 8.0 parts by weight based on 100 parts by weight of Ni.

23. The multilayer ceramic capacitor of claim 20, wherein the cathodic and anodic internal electrodes further include one or more conductive metals selected from the group consisting of Cu, Ag, Pd, Au, and an alloy thereof.

24. The multilayer ceramic capacitor of claim 17, wherein the dielectric layer comprises a barium titanate based compound and a subcomponent comprising one or more selected from the group consisting of Mn, Cr, Si, Al, Mg, Sn, Sb, Ge, Ga, In, Ba, La, Y, Ac, Pr, Nd, Pm, Sm, Eu, Gd, Tb, Dy, Ho, Er, Tm, Yb, Lu, Hf and V.
